(19) United States
(12) Patent Application Publication
(10) Pub. No.: US 2001/0053300 A1
(43) Pub. Date: Dec. 20, 2001

(54) Image forming device

(75) Inventors: Yoshinori Endo, Toyota-shi (JP); Hiroshi Nobe, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 09/878,267

(22) Filed: Jun. 12, 2001

(30) Foreign Application Priority Data
Jun. 14, 2000 (JP) 2000-177915

(51) Int. Cl. G03G 15/00

(52) U.S. Cl. 399/394

(57) ABSTRACT

An image forming device includes a plurality of recording medium supply units, an offset amount memory, and a timing control unit. The recording medium supply units supply recording media. The offset amount memory stores an offset amount for each recording medium supply unit. Each offset amount is for compensating for positional shift in a recording medium supplied from a corresponding recording medium supply unit. The timing control unit retrieves, from offset amount memory, an offset amount corresponding to a presently used recording medium supply unit and performs image forming operations at a timing corrected by the retrieved offset amount.

### BACKGROUND OF THE INVENTION

1. Field of the Invention

The present invention relates to an image forming device, such as a laser printer.

2. Description of the Related Art

A laser printer outputs a laser beam based on image data and scans the laser beam across an electrically charged photosensitive drum at high speeds, to form an electrostatic to latent image on the photosensitive drum. Toner is supplied to the photosensitive drum to develop the electrostatic latent image into a visible toner image. The visible toner image is transferred onto a sheet interposed between the photosensitive drum and a transfer roller, thereby forming a toner image on the sheet based on the image data.

Laser printers are provided with a standard sheet supply tray as a standard feature. The sheet standard supply tray holds a stack of sheets. Laser printers can often be provided with further sheet supply trays as an option, that is, in addition to the standard supply tray. The lower trays are stacked one on top of each other in a multilevel configuration. By filling the different trays with different sized sheets, the user can easily print on a desired sheet size by selecting the corresponding sheet supply tray. The standard tray and the lower trays are all provided with a separate sheet feed roller for feeding one sheet at a time out from the tray and with transport rollers for further transporting the fed out sheets. Sheet supply trays can be constructed according to either a side registration supply method or a center registration supply method. In the side registration supply method, a reference plate for guiding the sheets is provided to the width-wise side of the sheets stacked in the sheet supply tray. In the center registration supply method, no such guide plate is provided. The supply rollers and transport rollers are positioned at the widthwise center of the sheet stack in the sheets supply tray. The center registration supply method is advantageous because there are fewer paper jams than the side registration supply method and also image fixation can be properly performed regardless of the sheet size.

In recent years, laser printers have been provided with a duplex printing unit that enables printing on both sides of each sheet.

Japanese Patent Application Publication No. SHO-63-207670 discloses that not all cut sheets are transported through the same position at the photosensitive drum, because of slipping, friction, and the like along the transport pathway from a sheet supply portion to a photosensitive drum. To overcome this problem, a means is provided in the sheet transport pathway for detecting the amount that sheets are shifted in a main scanning direction with respect to a reference position. Another means is provided for correcting timing of the start end of a main scanning signal, which is for determining start position of printing.

### SUMMARY OF THE INVENTION

Each lower tray has a positioning tolerance for the position where it is mounted. As a result, when stacked one on top of each other in a multilevel configuration, the lower trays can be positionally shifted from each other and the standard tray. Because of this positional shift between the trays, sheets supplied from the lower trays can be positionally shifted from sheets supplied from the standard tray.

Also, the sheet supply rollers can transport sheets at a slant from the tray. This can result in a further positional shift between sheets from different trays. This further positional shift is especially a problem when lower trays use the center registration supply method, because there is no reference plate to guide the sheets like in a side registration supply method. Also, positional shifts can occur in both widthwise directions of sheets.

When sheets are positionally shifted from each other, that is, by both dimensional tolerance and by slanted sheet feed, the sheets pass through the image forming unit of the printer shifted positionally from each other. As a result, the images of different sheets are shifted from each other so that the left and right margins of different sheets have different widths. This problem becomes more striking the greater the more stacked levels of lower trays.

It is an objective of the present invention to overcome the above-described problems and to provide an image forming device with a simple configuration capable of preventing positional shift in images caused by positional tolerance of different sheet supply trays or because of slanted sheet supply, so that images can always be formed with a uniform margin width.

In order to achieve the above-described objectives, an image forming device according to the present invention includes a plurality of recording medium supply units, an offset amount memory, and a timing control unit. The recording medium supply units supply recording media. The offset amount memory stores an offset amount for each recording medium supply unit. Each offset amount is for compensating for positional shift in a recording medium supplied from a corresponding recording medium supply unit. The timing control unit retrieves, from the offset amount memory, an offset amount corresponding to a presently used recording medium supply unit and performs image forming operations at a timing corrected by the retrieved offset amount.

With this configuration, when a recording medium is supplied from one of the recoding medium supply units during an image forming operation, the timing control unit retrieves, from the offset amount memory, the offset amount that corresponds to the recording medium supply unit presently being used. The timing control unit controls the image forming operation at a timing corrected by the retrieved offset amount. Therefore, even if the recording medium is shifted from the ideal position, that is, from the position where it should be, the timing control unit always corrects image forming position on the recording medium using the offset amount for the presently-used recording medium supply unit, so that images are always formed at the proper position on the recording medium without physically moving the recording medium. Accordingly, a simple configuration can successfully prevent positional shifts from occurring in images when recording media are supplied from the recording medium supply unit with some positional shift. Also, this configuration enables forming images at the proper position on the recording medium regardless of which recording medium supply unit supplies the recording medium.

It is desirable that the plurality of recording medium supply units be configured according to a center registration supply method. With this configuration, because the recording medium supply units use the center registration method, paper jams are less likely to occur than when using a side registration supply method, wherein a reference plate for guiding the sheets is provided at one edge with respect to the sheets' width. Also, image fixation can be properly performed regardless of the sheet size.

Also, in contrast to the side registration method, the center registration method uses no guide plate. For this reason, positional shift can be generated in both widthwise directions of the sheets during sheet supply, resulting in a large offset amount. However, according to the present invention the positional shift is constantly corrected using the offset amount. Therefore, images can be formed at the proper position without problems from positional shifts.

It is desirable that the timing control unit start laser scanning at a timing corresponding to each offset amount. With this configuration, the timing control unit starts scanning with the laser at a timing corrected by the offset amount for the supplied recording medium. Therefore, even if the recording medium is shifted from its ideal position, that is, from where it should be supplied to the photosensitive drum, images can be easily and reliably formed at the proper position on the recording medium.

The effects of the present invention are particularly striking when at least one of the recording medium supply units is a duplex printing unit. Each single recording medium follows a particularly long transport path during duplex printing. That is, first an image is formed on one surface of the recording medium supplied from one of the recording medium supply units. Then the recording medium is transported to the duplex printing unit and inverted by the duplex printing unit. Then an image is formed on the other side of the recording medium. Because the transport path before, through, and after the duplex printing unit is so long, the recording medium can be easily shifted out of position. However, according to the present invention, the timing control unit always corrects, using the offset amount, for positional shift in the recording medium supplied from the duplex printing unit. Therefore, even if the recording medium has positional shift, images will be formed at the proper position on both sides of the recording medium.

### BRIEF DESCRIPTION OF THE DRAWINGS

The above and other objects, features and advantages of the invention will become more apparent from reading the following description of the embodiment taken in connection with the accompanying drawings in which:

FIG. 1 is a cross-sectional side view showing a laser printer as an image forming device according to the embodiment of the present invention;

FIG. 2 is a cross sectional front view showing the laser printer of FIG. 1;

FIG. 3 (a) is a plan view showing an image formed at a proper position on a sheet that was supplied with no positional shift from a standard tray, thereby producing uniform margins;

FIG. 3 (b) is a plan view showing an image formed at a shifted position on a sheet that was supplied with positional shift from a third-from-bottom lower tray, thereby producing different sized left and right margins;

FIG. 3 (c) is a plan view showing an image formed at a shifted position on a sheet that was supplied with positional shift from a bottom lower tray, thereby producing different sized left and right margins;

FIG. 4 is a block diagram showing a control system of the laser printer;

FIG. 5 is a flowchart representing an offset amount setting program;

FIG. 6 is a flowchart representing an image forming program;

FIG. 7 is a flowchart representing an offset amount selection routine;

FIG. 8 is a flowchart representing a scanner start program;

FIG. 9 (a) is a timing chart representing processes performed during the scanner start program when scanning a sheet supplied from the standard tray; and

FIG. 9 (b) is a timing chart representing processes performed during the scanner start program when scanning a sheet supplied from a lower tray.

### DETAILED DESCRIPTION OF THE EMBODIMENT

Next, a laser printer according to an embodiment of the present invention will be described while referring to the attached drawings.

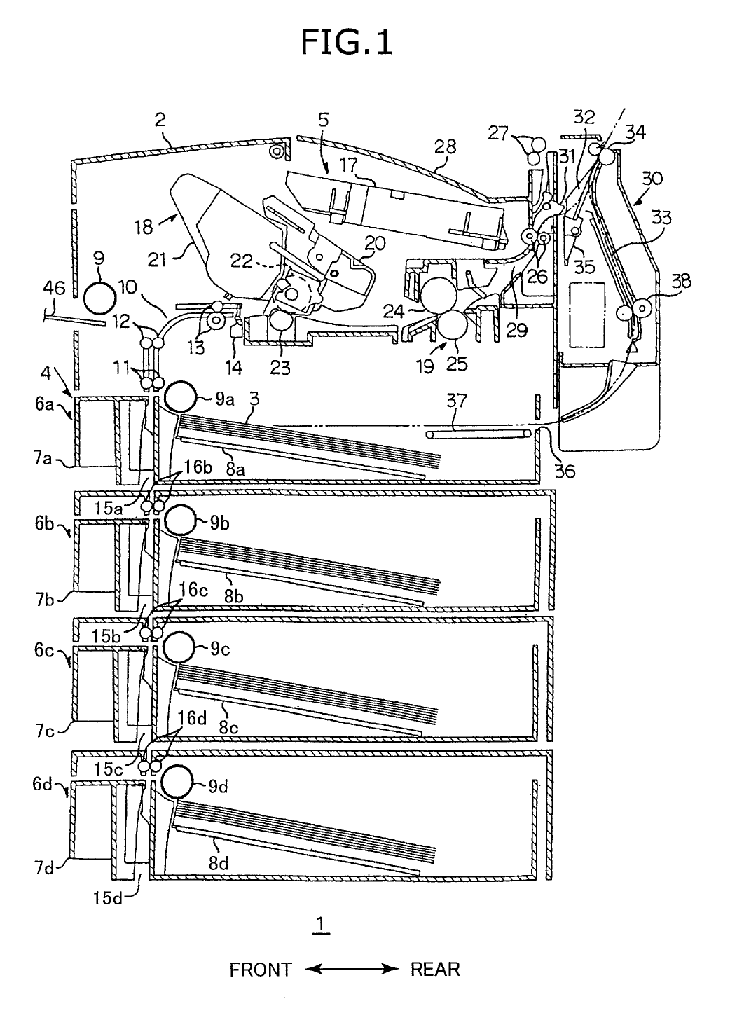

As shown in FIG. 1, the laser printer 1 includes a casing 2, a feeder unit 4, and an image forming unit 5. The feeder unit 4 and the image forming unit 5 are housed in the casing 2. The feeder unit 4 supplies sheets 3 to the image forming unit 5 and the image forming unit 5 forms images on the supplied sheets 3.

The feeder unit 4 includes a plurality of sheet supply trays 6a to 6d stacked vertically in a multi level configuration. That is, the sheet supply trays 6 include a standard tray 6a and lower trays 6b to 6d. The standard tray 6a is provided as a standard feature of the laser printer 1. The lower trays 6b to 6d are provided as options of the laser printer 1. The lower trays 6b to 6d are disposed in a stacked condition below the standard tray 6a.

The standard tray 6a is shaped like a box with an open upper surface. A grip portion 7a is provided at the front of the standard tray 6a. The standard tray 6a can be opened up in the manner of a desk drawer by grasping and pulling on the grip portion 7a. The standard tray 6a includes a sheet pressing plate 8a and a sheet feed roller 9a.

The sheet pressing plate 8a supports sheets 3 in a stacked condition. The sheet pressing plate 8a is swingably supported at its rear end, so that the front end can pivot vertically. Although not shown in the drawings, a spring is provided for urging the front end of the sheet pressing plate 8a upward. When the standard tray 6a is filled with a stack of sheets 3, the weight of the sheets 3 pivots the sheet pressing plate 8a downward against the upward urging force of the spring.

The sheet feed roller 9a is for feeding sheets from the stack on the sheet pressing plate 8a one at a time out from the standard tray 6a, and is disposed above the sheet pressing plate 8a. As the sheet feed roller 9a serially feeds sheets 3 out from the standard tray 6a, the spring provided to the under side of the sheet pressing plate 8a constantly pivots the front end of the sheet pressing plate 8a is upward so that the uppermost sheet 3 of the stack on the sheet pressing plate 8a is pressed up against the sheet feed roller 9a.

A transport path 15a penetrates vertically through the standard tray 6a at a position between the grip portion 7a and the sheet pressing plate 8a. The transport path 15a is for enabling sheets 3 transported from the lower trays 6b to 6d to pass through to the casing 2.

A rear opening portion 36 is formed in the rear wall of the standard tray 6a. The rear opening portion 36 is connected to a second inverting transport path 33 of an inversion transport unit 30 to be described later. A belt conveyor 37 is provided in the rear upper portion in the standard tray 6a. The belt conveyor 37 is for transporting sheets 3 received from the rear opening portion 36 to the sheet feed roller 9 during duplex printing operations.

A sheet supply path 10 shaped like a curved L is provided in the casing 2. The sheet feet path 10 is for guiding sheets 3 supplied from the standard tray 6a to the image forming unit 5. A pair of feed rollers 11, a pair of feed rollers 12, and a pair of registration rollers 13 are disposed along the sheet supply path 10. The pair of feed rollers 11 is disposed above the standard tray 6a. The pair of feed rollers 12 is disposed above the feed rollers 11. The pair of registration rollers 13 is disposed above and to the side of the pair of feed rollers 12.

Sheets 3 supplied from the standard tray 6a are transported through the sheet supply path 10 by the feed rollers 11 and 12 to the registration rollers 13, which perform a predetermined registration operation on the sheets 3 and afterward send the sheets to the image forming unit 5. A registration sensor 14 is provided at the downstream, that is, with respect to the transport direction of the sheets 3, end of the sheet supply path 10 at a position downstream from the registration rollers 13. The registration sensor 14 is for detecting whether sheets 3 have passed through the sheet supply path 10.

The lower trays 6b to 6d have a configuration similar to that of the standard tray 6a. That is, the lower trays 6b to 6d are shaped like a box with an open upper surface. Also, a grip portion 7b to 7d is provided to the front of each lower tray 6b to 6d. Each lower tray 6b to 6d can be opened up in the manner of a desk drawer by grasping and pulling on the corresponding grip portion 7b to 7d. Each lower tray 6b to 6d also includes a pressing plate 8b to 8d for supporting a stack of sheets 3 and a sheet feed roller 9b to 9d disposed above the sheet pressing plate 8b to 8d. Although not shown in the drawings, a spring is provided to the under side of each lower tray 6b to 6d. In the same manner as the standard tray 6a, each spring is for urging the upper most sheet 3 of the stack on the corresponding sheet pressing plate 8b to 8d toward the sheet feed roller 9, whereupon rotation of the corresponding sheet feed roller 9b to 9d feeds out one sheet at a time.

A transport path 15b to 15d penetrates vertically through the lower trays 6b to 6d between each set of grip portions 7b to 7d and the sheet pressing plates 8b to 8d. The transport path 15b to 15d is for enabling sheets 3 transported from the lower trays 6c to 6d to pass through to the casing 2. The transport path 15a of the standard tray 6a and the lower trays 6b to 6d are connected in the vertical direction. A pair of transport rollers 16b to 16d is provided to each of the lower trays 6b to 6d at the upper end of the transport path 15b to 15d in the corresponding lower tray 6b to 6d and is for transporting the sheets 3 further upward in the transport path 15a to 15d.

Here, sheet supply operations of the lower tray 6b, which is the third tray from the bottom, will be described. When a sheet 3 is fed out from the lower tray 6b, the transport rollers 16b provided in the lower tray 6b transport the sheet 3 to the transport path 15a of the standard tray 6a. After the sheet 3 passes through the transport path 15a, it is transported through the sheet supply path 10 to the image forming unit 5.

Next, sheet supply operations of the lower tray 6d, which is the lowermost tray, will be described. When a sheet 3 is supplied from the lower tray 6d, first the transport rollers 16d provided in the lower tray 6d transport the sheet 3 to the transport path 15c of the lower tray 6c, which is the second tray from the bottom. The transport rollers 16c provided to the transport path 15c transport the sheet 3 to the transport path 15b of the lower tray 6b, which is the third tray from the bottom. The transport rollers 16b provided in the transport path 15b transport the sheet 3 to the transport path 15a of the standard tray 6a. After the sheet 3 passes completely through the transport path 15a to 15d, it is transported through the sheet supply path 10 to the image forming unit 5.

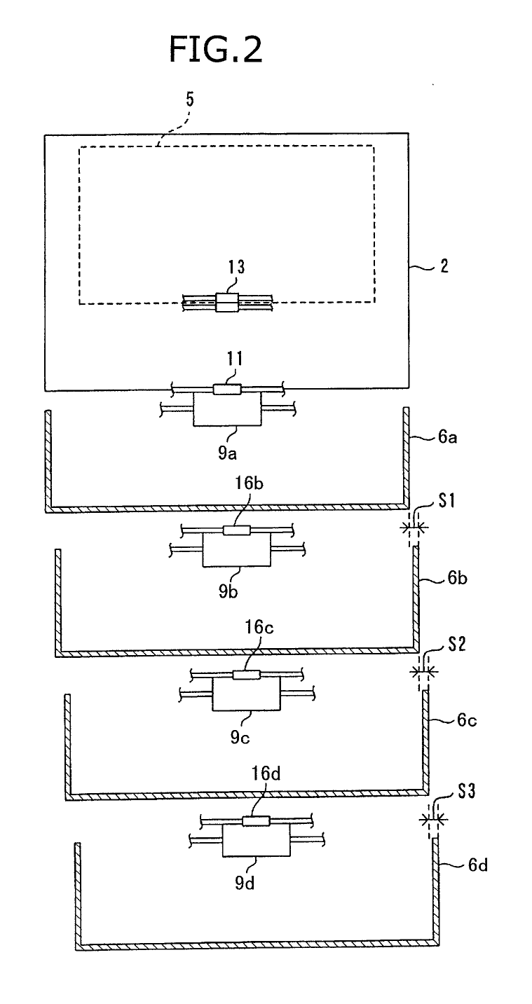

The center registration supply method is used to perform the sheet supply and transport operations in the standard tray 6a and the lower trays 6b to 6d. That is, as shown in FIG. 2, the supply rollers 9a to 9d and transport rollers 16b to 16d rotatably provided to the standard tray 6a and the lower trays 6b are disposed in the widthwise AS center of the sheets 3. The center registration supply method has less problems with paper jams than the side registration supply method, wherein a reference plate for guiding the sheets is provided at one edge with respect to the sheets' width. Also, image fixation can be properly performed regardless of the sheet size.

As shown in FIG. 1 a manual feed unit including a multipurpose tray 46 and a sheet feed roller 9 is provided at an opening in the front wall of the casing 2. The sheet feed roller 9 is for feeding sheets 3 from the multipurpose tray 46. The sheet feed roller 9 of the manual feed unit also uses the center registration supply method.

The image forming unit 5 includes a scanner unit 17, a developing unit 18, and a fixing unit 19. The developing unit 18 is disposed below the scanner unit 17.

The scanner unit 17 is provided at the upper portion of the casing 2. Although not shown in the drawings, the scanner unit 17 includes a laser light emitting portion, a polygon mirror, and a plurality of lenses and reflection mirrors. The scanner unit 17 operates in the following manner. The laser light emitting portion emits a laser beam based on image data. The laser beam is transmitted and reflected by the polygon mirror, the lenses, and the reflection mirrors to be scanned at a high speed across the surface of a photosensitive drum 22 of the developing unit 18.

The developing unit 18 includes a drum cartridge 20 and a developing cartridge 21, both freely detachable with respect to the casing 2. The drum cartridge 20 includes the photosensitive drum 22 and a scorotron charge unit (not shown). The scorotron charge unit is for charging the surface of the photosensitive drum 22. Although not shown, the developing cartridge 21 includes a toner supply portion, a developing roller, a supply roller, and a layer-thickness regulating blade.

Rotation of the supply roller supplies toner housed in the toner housing portion to the developing roller. As the developing roller rotates, the layer-thickness regulating blade regulates the toner supplied onto the developing roller into a thin layer of fixed thickness. As the scorotron charge unit charges the surface of the photosensitive drum 22 to a uniform charge, the scanner unit 17 scans the laser beam based on image data across the uniformly charged surface of the photosensitive drum 22 to expose and form an electrostatic image on the surface of the photosensitive drum 22. As the developing roller rotates, toner borne on the developing roller contacts the photosensitive drum 22 and is selectively transferred to the electrostatic latent image on the surface of the photosensitive drum 22, so that the electrostatic latent image is developed into a visible toner image.

The transfer roller 23 is rotatably disposed below and in confrontation with the photosensitive drum 22. For this reason, the visible image borne on the photosensitive drum 22 is transferred to a sheet 3 while the sheet 3 passes between the photosensitive drum 22 and the transfer roller 23.

The fixing unit 19 is disposed downstream from the developing unit 18 and includes a heat roller 24 and a pressing roller 25, which presses against the heat roller 24. The heat roller 24 is made from metal and includes a halogen lamp for heating the heat roller 24. The heat roller 24 thermally fixes the toner transferred onto the sheet 3 in the developing unit 18 onto the sheet 3 while the sheet 3 passes between the heat roller 24 and the pressing roller 25.

An arch-shaped sheet discharge path 29 and a sheet discharge tray 28 are provided downstream from the fixing unit 19. The sheet discharge path 29 is for guiding the sheets 3 from the fixing unit 19 to the sheet discharge tray 28. A pair of transport rollers 26 are provided along the sheet discharge path 29 and transport sheets 3 that were thermally fixed in the fixing unit 19 through the sheet discharge path 29. A pair of sheet discharge rollers 27 are disposed above the transport rollers 26 for discharging sheets 3 from the sheet discharge path 29 onto the sheet discharge tray 28.

A first flapper 31 switching transport direction of sheets 3 is provided in the sheet discharge path 29 at a position between the transport rollers 26 and the sheet discharge rollers 27. Although not shown in the drawings, a solenoid is provided for swinging the first flapper 31 to selectively expose and cover the transport pathway of the sheet discharge path 29. That is, by selectively energizing and deenergizing the solenoid, the first flapper 31 switches transport direction of sheets transported from the transport roller 26 to either toward the sheet discharge roller 27 or toward the inversion transport unit 30.

The inversion transport unit 30 is provided to the laser printer 1 to enable the laser printer 1 to print on both sides of the sheets 3. The inversion transport unit 30 includes a first inversion transport path 32 for receiving and guiding transport direction of sheets 3 from the sheet discharge path 29, a pair of inversion rollers 34 for transporting sheets 3 out of the casing 2, and a second inversion transport path 33 for transporting the sheets 3 from the inversion rollers 34 to the standard tray 6a. The inversion rollers 34 are formed from a pair of rollers capable of switching between forward and reverse rotation.

The first inversion transport path 32 is for transporting sheets 3 diagonally upward. The first inversion transport path 32 extends from where the first flapper 31 divides transport direction of sheets 3 in the sheet discharge path 29 to the pair of inversion rollers 34, wherein the upstream end of the first inversion transport path 32 is connected to the sheet discharge path 29 and the downstream end is disposed adjacent to the inversion roller 34.

The second inversion transport path 33 is for transporting sheets 3 downward from the inversion rollers 34 to the standard tray 6a and extends from its upstream end near the inversion rollers 34 to its downstream end connected to the rear opening portion 36 of the standard tray 6a. A pair of transport rollers 38 is disposed along the second inversion transport path 33.

The second flapper 35 is swingably provided to selectively expose and cover the connection between the first inversion transport path 32 and the second inversion transport path 33. Although not shown, a solenoid is provided to drive the swinging operation of the second flapper 35. That is, by energizing and deenergizing the solenoid, the second flapper 35 switches to guide sheets 3 transported from the inversion roller 34 to either toward the first inversion transport path 32 or toward the second inversion transport path 33.

During duplex printing, the first flapper 31 is switched to a guide sheet 3 that has been formed on one side with an image from the transport rollers 26 into the first inversion transport path 32. The inversion rollers 34 are rotated in the forward direction to transport the sheet 3 upward until most of the sheet 3 is transported out of the casing 2 and only the rear edge of the sheet 3 is sandwiched between the inversion rollers 34. At this time, forward rotation of the inversion rollers 34 is stopped. Next, the inversion rollers 34 are rotated in reverse. The second flapper 35 is switched to guide the sheet 3 into the second inversion transport path 33. At this point, the orientation of the sheet 3 is inverted, that is, with front and rear sides reversed. After the sheet 3 has been transported into the second inversion transport path 33, the first and second flappers 31, 35 switch back to their initial positions.

The sheet 3 is transported through the second inversion transport path 33 to the rear opening 36 of the standard tray 6a. The belt conveyor 37 transports the sheet 3 from the rear opening 36 to the sheet feed rollers 9. The sheet feed rollers 9 then feed out the sheet 3 a second time, this time in an upside down condition, to the image forming unit 5, which forms an image on the second side of the sheet 3. In this way, images are formed on both sides of the same sheet 3.

In the laser printer 1 with this configuration, the lower trays 6b to 6d, which are provided as options of the laser printer 1, each have a positioning tolerance for where it is mounted. Therefore, sheets 3 supplied from the lower trays 6b to 6d be shifted with respect to sheets 3 supplied from the standard tray 6a. The positional shift is equivalent to the positioning tolerance. Also, when the sheets 3 are transported at a slant, the sheets 3 can be position shifted from the ideal location for toner image transfer between the photosensitive drum 22 and the transfer roller 23. When a sheet is shifted from the ideal location, that is, when the combination of these two types of shift result in a positional shift of the sheet, the left and right margins of images on the sheet 3 will be different from the margins of images printed on sheets supplied from the standard tray 3.

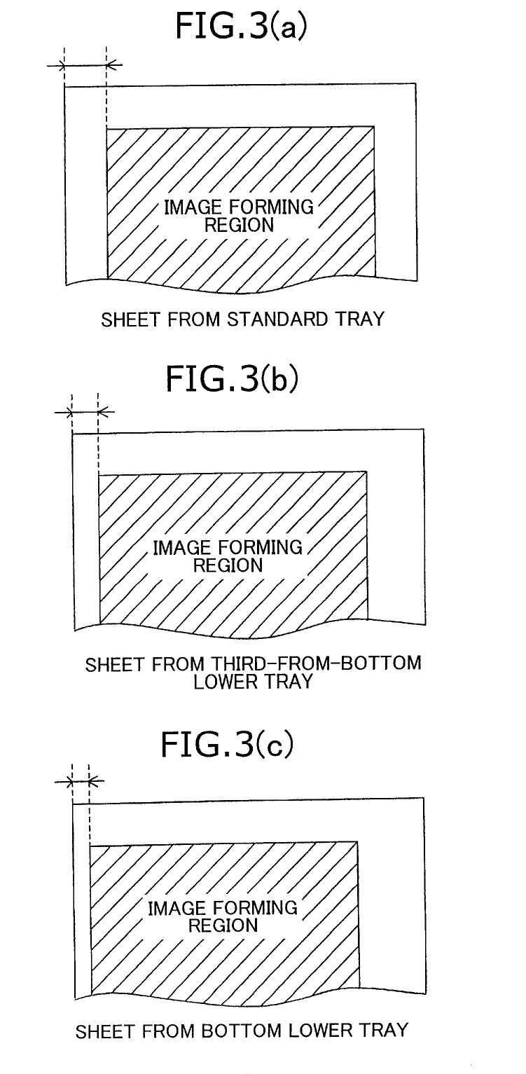

As shown in FIG. 2, the lower trays 6b, 6c, 6d in the present embodiment have a positioning tolerance S1, S2, S3, respectively, in the widthwise direction of the sheets 3. As a result, a sheet supplied from, for example, the third-from-the bottom lower tray 6b will have a positional shift corresponding to the tolerance S1 with respect to a sheet 3 supplied from the standard tray 6a. The sheet 3 can also be shifted out of position if the transport rollers 16b provided to the lower tray 6b transport the sheet 3 at a slant. When a sheet is shifted from its ideal position at the photosensitive drum, then the image can be printed on the printed sheet 3 with different margins at left and right sides of the image as shown in FIG. 3 (b). As can be understood by comparing in FIGS. 3 (a) and 3 (b), the image printed on the sheet 3 from the third-from-bottom lower tray 6b at a position is shifted to the left compared with the image printed on the sheet 3 from the standard tray 6a. As a result, the left margin is smaller than the right margin on the printed sheet 3 from the third-from-bottom lower tray 6b.

The absolute shift is even more extreme in the case of sheets 3 supplied from the bottom lower tray 6d. That is, the bottom lower tray 6d has the largest positional shift, which is equivalent to the sum of all of the positioning tolerances S1, S2, and S3. Also, sheets 3 from the bottom lower tray 6d are transported the longest distance by the transport rollers 16d provided in the bottom lower tray 6d, the transport rollers 16c provided in the second-from-bottom lower tray 6c, and the transport roller 16b provided to the third-from-bottom lower tray 16b. Therefore, any slanted transport occurring along this long distance will cause a great positional shift. A large absolute positional shift results from the combination of this large positioning tolerance positional shift and great slanted transport positional shift, so that when the toner image is transferred to the sheet 3, the image is greatly shifted out of position compared with the position of images printed on sheets 3 from the standard tray 6a. In the example of FIG. 3 (c), the left margin is even smaller than the right margin.

Further, the positional shifts in the widthwise directions of the sheets are even more striking because the laser printer 1 uses the center registration supply method to feed and transport sheets from the standard tray 6a and the lower trays 6b to 6d. No guide plate is provided in the center registration supply method, in contrast to the side registration method.

It should be noted that the lower trays 6b to 6d are normally formed from resin using the same metal mold.

Therefore, the positioning tolerance is normally the same value for all of the lower trays 6b to 6d, that is, positioning tolerance S1 is the same as tolerance S2, which is the same as positioning tolerance S3. Accordingly, the positional shift of the sheet 3 at the time of image transfer increases by a fixed amount, that is, by the positioning tolerance S1, for each additional tray level.

For example, the positional shift in sheets 3 supplied from the bottom lower tray 6d compared with sheets 3 supplied from the standard tray 6a is three times the positioning tolerance S1 (S1×3).

Positional shifts in sheets 3 are not only generated when sheets are supplied from the lower trays 6b to 6d; a positional shift can also be generated in sheets 3 during duplex printing when the sheets are inverted by the inversion transport unit 30 and then again supplied from the standard tray 6a by the sheet feed roller 9a. That is, during duplex printing, a sheet 3 with an image already 20 formed on one side is transported to a position between the inversion rollers 34 in the inversion transport unit 30, through the transport path 33 by the inversion rollers 34, to the standard tray 6a by the transport rollers 38, and to the sheet feed roller 9a by the belt conveyor 37. Next, the sheet 3 is again supplied to the image forming unit 5 by the sheet feed roller 9a to be formed with an image on the opposite side. Because the sheet 3 is transported along such a long transport path during duplex printing, the positional shift created by slanted movement during transport of the sheet 3 is also great. For this reason, the positions of margins on one printed side will be different from the positions of margins on the other printed side.

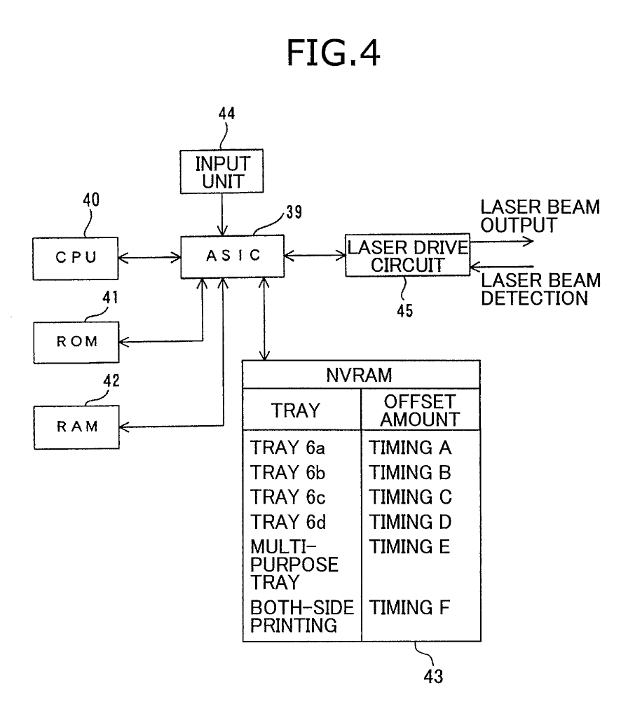

Offset amounts for compensating for these different positional shifts are prestored in an NVRAM 43 to be described later. The offset amounts are predetermined by judging, by experience, the amount that same sized sheets 3 transported from the lower trays 6b to 6d will be positional shifted at the time of image transfer and the amount that sheets again supplied from the sheet feed roller 9a of the standard tray 6a after being inverted by the inversion transport unit 30 will be positional shifted at the time of image transfer. These amounts are stored as the offset amounts in an NVRAM 43 as shown in FIG. 4. When images are to be formed, offset amounts assumed to be generated for each of the sheet supply sources, that is, the lower trays 6a, 6b, 6c, and 6d, and during duplex printing are retrieved from the NVRAM 43 based on the present type of printing operation. Image forming operations are performed at a timing corrected by the retrieved offset amount in a manner to be described in more detail later.

FIG. 4 is a block diagram showing a control system of the laser printer 1. The control system includes an application specific integrated circuit (ASIC) 39 connected to a central processing unit (CPU) 40, a read only memory (ROM) 41, a random access memory (RAM) 42, a non-volatile RAM (NVRAM) 43, an input unit 44, and a laser drive circuit 45. The ROM 41 stores a variety of programs to be described later, including an offset amount setting program, an image forming program, and a scan start program. The RAM 42 includes regions for temporarily storing setting values set based on operation of the various above-described programs. The NVRAM 43 stores the offset amounts that correspond to each sheet supply source and to duplex printing. The input unit 44 is for inputting condition setting data and can be the operation panel provided to the laser printer 1 or an external personal computer, for example. The laser drive circuit 45 controls the scanner unit 17 to scan a laser beam across the charged surface of the photosensitive drum 22. The CPU 40 performs computations to control these various components.

First, the amounts of different potential positional shifts are determined based on experience. The amounts determined are the amounts that the same-sized sheet 3 supplied from the lower trays 6b to 6d will be positional shifted at time of image transfer and the amount that sheets that are again supplied from the sheet feed roller 9a of the standard tray 6a after the sheet is inverted by the inversion transportation unit 30 will positionally shifted at the time of image transfer. These amounts are stored in the NVRAM 43 as offset amounts in correspondence with each sheet supply source and with duplex printing. The offset amounts represent the amounts that sheets supplied from each of the sheet supply sources will be positionally shifted from a reference position at the time of image transfer. One way to determine the offset amounts is for an operator to use the printer to print out an image while the printer is set with an offset value of zero. The operator then measures how far shifted the image is from an ideal position, that is, from a reference position. For example, the operator uses the printer to print an image with a left margin set to 5 mm. If the actual image has a margin of 8 mm, then the operator will determine that a 3 mm shift was generated and set the offset value to 3 mm. The offset values are set from the operation panel of the printer before the printer is shipped from the factory. Positional shifts may develop after the printer has been used for a long time. In this case, the offset values can be adjusted using the operation panel of the printer or a personal computer. The offset amounts are stored in the NVRAM 43 with other settings before the laser printer 1 is shipped from the factory.

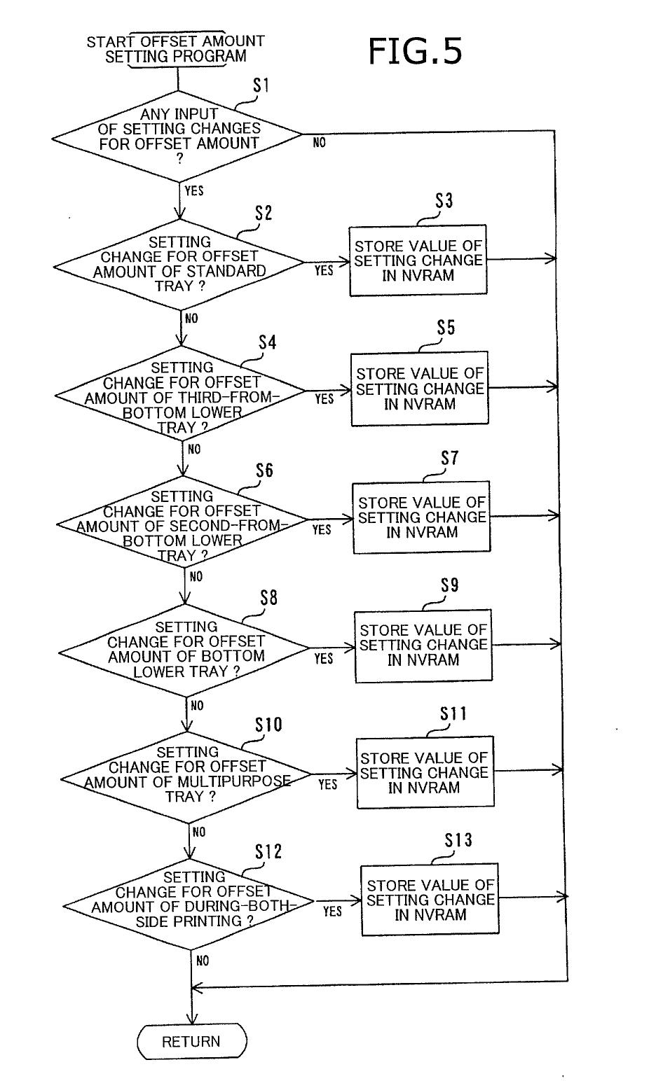

Operations during the offset amount setting program will be explained with reference to the flowchart in FIG. 5.

When the offset amount setting program is started, it is judged whether or not input for changing a setting of one of the offset amounts has been input from the input unit 44 (S1). If so (S1:YES) , then it is judged whether or not the input is for changing the setting of the offset amount of the standard tray 6a (S2). If so (S2:YES), then the value of the setting change is stored in the NVRAM 43 (S3) and the program is ended. It should be noted that if no setting change for offset amount is input from the input unit 44 (S1:NO), then the program ends immediately.

If no setting change for the offset amount of the standard tray 6a has been input (S2:NO), then it is judged whether or not a setting change for the offset amount of the third-from-bottom lower tray 6b has been input (S4). If so (S4:YES), then the value of the setting change is stored in the NVRAM 43 (S5) and the program is ended.

If no setting change for the offset amount of the third-from-bottom lower tray 6b has been input (S4:NO), then it is judged whether or not a setting change for the offset amount of the second-from-bottom lower tray 6c has been input (S6). If so (S6:YES) , then the value of the setting change is stored in the NVRAM 43 (S7) and the program is ended.

If no setting change for the offset amount of the second-from-bottom lower tray 6c has been input (S6:NO), then it is judged whether or not a setting change for the offset amount of the bottom lower tray 6d has been input (S8). If so (S8:YES) , then the value of the setting change is stored in the NVRAM 43 (S9) and the program is ended.

If no setting change for the offset amount of the bottom lower tray 6d has been input (S8:NO), then it is judged whether or not a setting change for the offset amount of the multipurpose tray 46 has been input (S10) If so (S10:YES), then the value of the setting change is stored in the NVRAM 43 (S11) and the program is ended.

If no setting change for the offset amount of the multipurpose tray 46 has been input (S10:NO), then it is judged whether or not a setting change for the offset amount for duplex printing has been input (S12). If so (S12:YES), then the value of the setting change is stored in the NVRAM 43 (S13) and the program is ended.

Operations of the offset amount setting program would normally be performed at the factory according to setting values input from a personal computer, which serves as the input unit 44. However, setting changes can be performed during maintenance of the laser printer 1, wherein either a personal computer or an operation panel of the laser printer 1 would serve as the input unit 44. Also, the offset amount setting program is designed to enable setting the offset amounts of the standard tray 6a and the multipurpose tray 46 so that any positional shifts generated in the standard tray 6a and the multipurpose tray 46 can be dealt with.

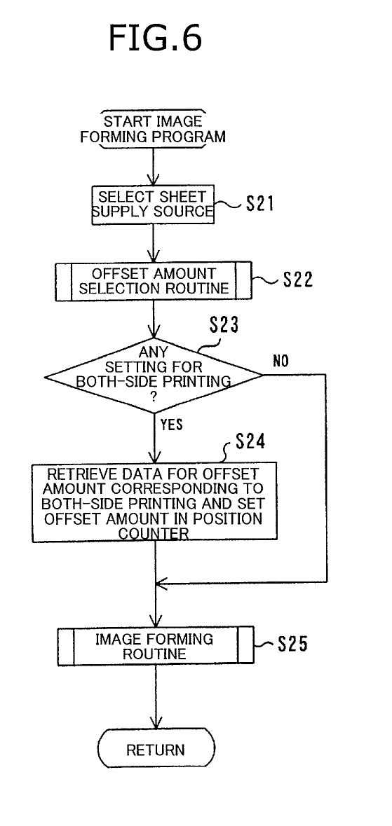

The laser printer 1 with offset amounts for each sheet supply source and for duplex printing stored in the NVRAM 43 performs image forming process according to the image forming program represented by the flowchart in FIG. 6. This program is started up when a print job is input from a personal computer, for example. When this program is started up, then a sheet supply source indicated in the print job is selected (S21). Then, an offset amount selection routine is performed to select the offset amount that corresponds to the selected sheet supply source (S22).

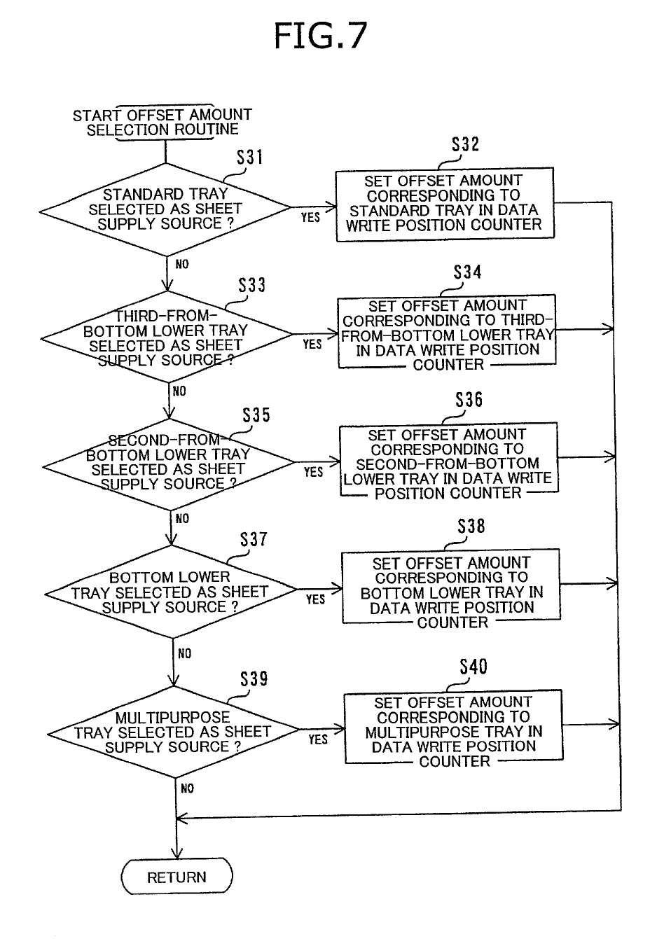

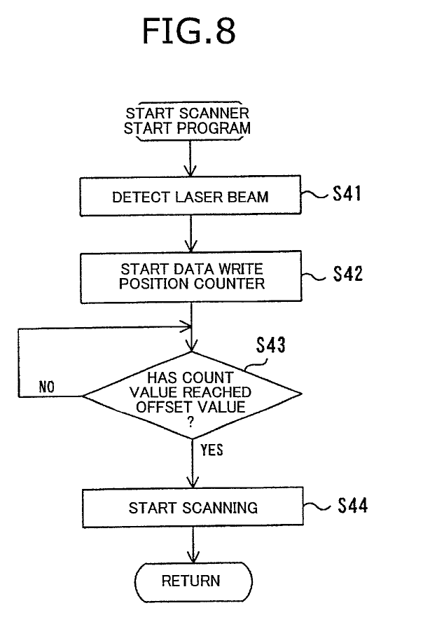

The offset amount selection routine is performed as represented by the flowchart of FIG. 7. First, it is judged whether or not the standard tray 6a is selected as the sheet supply source (S31). If so (S31:YES) and an offset amount is stored in the NVRAM 43 in correspondence with the standard tray 6a, then the offset amount is retrieved from the NVRAM 43 and set as the offset value in a data write position counter used during the scanner start program represented by the flowchart in FIG. 8 (S32) . If the standard tray 6a is not selected as the sheet supply source (S31:NO), then it is judged whether or not the third-from-bottom lower tray 6b is selected as the sheet supply source (S33). If so (S33:YES), then the offset amount stored in the NVRAM 43 in correspondence with the third-from-bottom lower tray 6b is retrieved from the NVRAM 43 and set as the offset value in a data write position counter (S34). If the third-from-bottom lower tray 6b is not selected as the sheet supply source (S33:NO), then it is judged whether or not the second-from-bottom lower tray 6c is selected as the sheet supply source (S35). If so (S35:YES), then the offset amount stored in the NVRAM 43 in correspondence with the second-from-bottom lower tray 6c is retrieved from the NVRAM 43 and set as the offset value in a data write position counter (S36). If the second-from-bottom lower tray 6c is not selected as the sheet supply source (S35:NO), then it is judged whether or not the bottom lower tray 6d is selected as the sheet supply source (S37). If so (S37:YES), then the offset amount stored in the NVRAM 43 in correspondence with the bottom lower tray 6d is retrieved from the NVRAM 43 and set as the offset value in a data write position counter (S38). If the bottom lower tray 6d is not selected as the sheet supply source (S37:NO), then it is judged whether or not the multipurpose tray 46 is selected as the sheet supply source (S39). If so (S39:YES), then the offset amount stored in the NVRAM 43 in correspondence with the multipurpose tray 46 is retrieved from the NVRAM 43 and set as the offset value in a data write position counter (S40).

Returning to the flowchart of FIG. 6, after the offset value corresponding to the sheet supply source is selected, it is judged whether or not the print job requires duplex printing (S23). When there is a setting for duplex printing (S23:YES), then the offset value in correspondence with duplex printing is retrieved from the NVRAM 43 and set as the offset value in the data write position counter (S24). It should be noted that the offset value set for duplex printing in the data write position counter is set separately from the offset value set for the sheet supply source. The offset value set for duplex printing is used instead of the offset value corresponding to the presently set sheet supply source in the scanner start program when duplex printing is performed. When no command is present for duplex printing (S23:NO) or when the offset value for duplex printing is set (S24) then an image forming routine is performed (S25). That is, during the image forming routine, a sheet 3 is supplied from the feeder unit 4 and images are formed on the sheet 3 by the image forming unit 5.

During the image forming routine, the timing where the scanner unit 17 starts scanning the laser beam on the surface of the photosensitive drum 22 is corrected according to the offset value set in the data write position counter. As a result, images can be formed at the proper position on the sheet 3, even if the sheet 3 has some positional shift at time of image transfer onto the sheet 3.

This control is performed by processes of the scan start program represented by the flowchart of FIG. 8. When this program is started, first the laser beam is detected (S41). Detection of the laser beam acts as a trigger for starting the data write position counter (S42). Next, when the count value in the data write position counter reaches the offset value set in the data write position counter (S43:YES), then the scanner unit 17 starts scanning the laser beam across the surface of the photosensitive drum 22 (S44). The scanner start program is executed once for each line scanned by the laser beam.

As a result, each line of the electrostatic latent image formed on the photosensitive drum 22 is corrected by the offset value based on the offset amount for the sheet supply source or duplex printing. Therefore, when the electrostatic latent image is developed and transferred onto the sheet 3 as a toner image, the image will be formed on the sheet 3 at the proper position, even if the absolute positional shift of the sheet 3 is uncorrected at the time of image transfer.

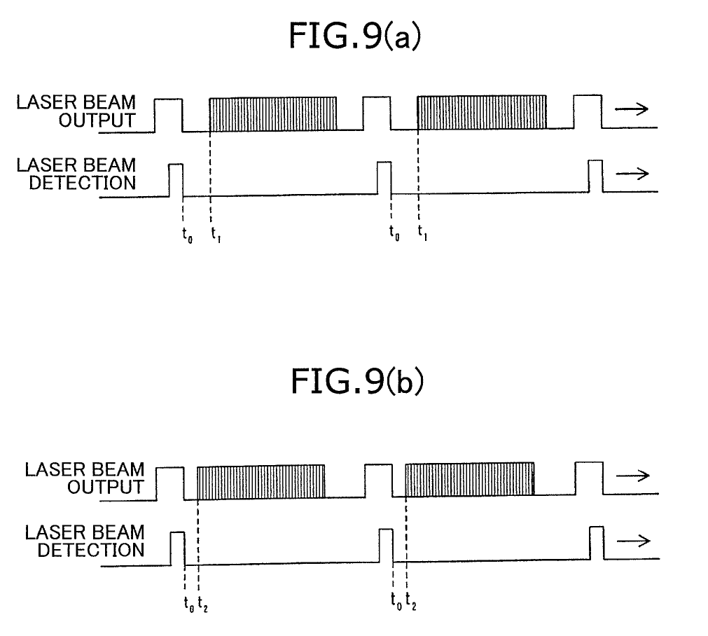

FIG. 9 (a) shows an example wherein the standard tray 6a has no positional shift and accordingly no offset value is set for the standard tray 6a. The laser beam is output and detected at a detection time to, whereupon the data write position counter is started. Scanning is started once the count value of the data write position counter reaches a preset reference value t₁. This process is repeated for each scan line.

FIG. 9 (b) shows an example wherein positional shift is generated in a sheet 3, either from one of the lower trays 6b to 6d or from duplex printing. In this case also, the data write position counter is started after the laser beam is detected at time t₀. However, the scanner unit 17 starts scanning when the data write position counter reaches the presently set offset value t₂. Therefore, scanning is started at an earlier, or later, timing. Because this process is repeated for each scan line, the electrostatic latent image formed on the surface of the photosensitive drum 22 is corrected for each line by the presently set offset amount.

Accordingly, a simple configuration that only controls timing of when scanning by the laser beam starts can reliably compensate for positional shifts of the image at time of image formation caused by positional shifts of sheets 3 supplied from the lower trays 6b to 6d. Accordingly, even though the lower trays 6b to 6d use the center registration supply method so that positional shifts are easily generated in the widthwise direction of the sheet 3, images with proper margins can be formed on the sheets 3.

During duplex printing as well, in the same manner as described above, position shifts caused in formed images when a sheet 3 is inverted by the inversion transport unit 30 and again supplied from the sheet feed roller 9a of the standard tray 6a can also be reliably prevented. Accordingly, duplex printing can be performed with image properly positioned.

While the invention has been described in detail with reference to specific embodiments thereof, it would be apparent to those skilled in the art that various changes and modifications may be made therein without departing from the spirit of the invention, the scope of which is defined by the attached claims.

For example, the embodiment describes the laser printer 1 as being provided with three lower trays 6b to 6d. However, there is no particular limit to the number of sheet supply trays that are provided.

Also, the embodiment describes offsetting the print position by changing a data write position. However, the same effects can be achieved by changing the offset amount by adding or deleting print data for white pixels.

When sheets 3 of different sizes are used in the laser printer 1, the offset amount can be added or subtracted in accordance with the size of the sheet presently being formed with an image.

The embodiment describes that a software counter is used to realize the operations represented by the flowchart of FIG. 8. However, a hardware counter could be used to realize the operations.

What is claimed is:

1. An image forming device comprising:
a recording medium supply unit that accommodates and supplies a recording medium with positional shift; and
a control unit that controls image formation on the supplied recording medium to a position adjusted according to an offset amount for compensating for the positional shift in the recording medium supplied from the recording medium supply unit.

2. An image forming device as claimed in claim 1, wherein the recording medium supply unit is configured according to a center registration supply method.

3. An image forming device as claimed in claim 1, wherein the control unit controls timing of image formation to adjust position of image formation on the supplied recording sheet.

4. An image forming device as claimed in claim 3, further comprising:
a photosensitive body formed at its surface with a uniform charge;
a laser scanner that scans the surface of the photosensitive body with laser light to form a latent electrostatic image on the photosensitive body;
a developing unit that develops the latent electrostatic image into a visible image with developing agent; and
a transfer unit that transfers the visible image onto the recording medium supply unit, the control unit controlling the laser scanner to start laser scanning at a timing according to the offset amount.

5. An image forming device as claimed in claim 1, wherein the recording medium supply unit is a duplex printing unit.

6. An image forming device as claimed in claim 1, further comprising:
a plurality of recording medium supply units that supply recording media; and
an offset amount memory that stores an offset amount for each recording medium supply unit, each offset amount being for compensating for positional shift in a recording medium supplied from a corresponding recording medium supply unit, the control unit retrieving, from the offset amount memory, an offset amount corresponding to a presently used recording medium supply unit and controlling image formation on the supplied recording medium to a position adjusted according to the retrieved offset amount.

7. An image forming device comprising:
image forming means for forming an image on a recording medium;
recording medium supply means for accommodating and supplying a recording medium to the image forming means;
offset amount memory means for storing an offset amount for compensating for positional shift, at the image forming means, in the recording medium supplied from the recording medium supply unit to the image forming means;
offset amount retrieval means for retrieving the offset amount from the offset amount memory means; and
image position adjusting means for adjusting image formation on the supplied recording medium to a position adjusted according to the offset amount.

8. An image forming device as claimed in claim 7, wherein the recording medium supply means is configured according to a center registration supply method.

9. An image forming device as claimed in claim 7, wherein the image forming means includes:
a photosensitive body formed at its surface with a uniform charge;
a laser scanner that scans the surface of the photosensitive body with laser light to form a latent electrostatic image on the photosensitive body;
a developing unit that develops the latent electrostatic image into a visible image with developing agent; and
a transfer unit that transfers the visible image onto the recording medium supply unit, the image position adjusting means controlling the laser scanner to start laser scanning at a timing according to the offset amount.

10. An image forming device as claimed in claim 7, wherein the recording medium supply means is a duplex printing unit.

11. An image forming device as claimed in claim 1, further comprising a plurality of recording medium supply means that supply recording media, the offset amount memory means storing an offset amount for each recording medium supply means, each offset amount being for compensating for positional shift in a recording medium supplied from a corresponding recording medium supply means, the offset amount retrieval means retrieving, from the offset amount memory means, an offset amount corresponding to a presently used recording medium supply unit, the image position adjusting means controlling image formation on the supplied recording medium to a position adjusted according to the retrieved offset amount.
